(19) United States
(12) Patent Application Publication
(10) Pub. No.: US 2012/0163034 A1
(43) Pub. Date: Jun. 28, 2012

(54) SWITCHING MODE POWER SUPPLY HAVING MULTIPLE OUTPUT

(75) Inventors: Young Joo KIM, Gwangju (KR); Ho Jae Lee, Suwon (KR); Min Kim, Suwon (KR); Ki Soo Kim, Anyang (KR)

(73) Assignee: SAMSUNG ELECTRO-MECHANICS CO., LTD.

(21) Appl. No.: 13/333,167

(22) Filed: Dec. 21, 2011

(30) Foreign Application Priority Data
Dec. 24, 2010 (KR) 10-2010-0134517

(51) Int. Cl. H02M 3/24

(52) U.S. Cl. 363/15

(57) ABSTRACT

There is provided a switching mode power supply having multiple outputs, including: a DC/DC converter converting a DC voltage level according to a change in a load and including a primary coil and a secondary coil; a boost unit boosting an output voltage of the DC/DC converter in a first mode and outputting the boosted output voltage to an output terminal; a bypass unit bypassing the output voltage of the DC/DC converter in a second mode, to output the bypassed voltage to the output terminal; and a boosting controller controlling the boost unit according to a voltage detected at a center tab of the secondary coil of the DC/DC converter.

### CROSS-REFERENCE TO RELATED APPLICATIONS

This application claims the priority of Korean Patent Application No. 10-2010-0134517 filed on Dec. 24, 2010, in the Korean Intellectual Property Office, the disclosure of which is incorporated herein by reference.

### BACKGROUND OF THE INVENTION

1. Field of the Invention

The present invention relates to a switching mode power supply capable of outputting multiple voltages.

2. Description of the Related Art

Generally, a switching mode power supply capable of satisfying a demand for miniaturization and high efficiency has been widely used as a power supply. When there is a need to supply a separate voltage, according to an operation mode of a load, a switching mode power supply capable of generating multiple outputs may be used.

The switching mode power supply having multiple outputs according to the related art uses a voltage of a center tab of a transformer or a plurality of transformers to supply a standby voltage among operation modes of a load.

However, even when the switching mode power supply having multiple outputs according to the related art supplies a voltage required in a standby mode using a center tab, a DC/DC converter generates a voltage higher than a voltage necessary for the standby mode, thereby increasing power consumption due to heat generation, or the like.

Further, when the plurality of transformers are used, the number of components is increased.

Furthermore, when the power supply having multiple outputs is applied to an external adapter, output terminals are configured in a number of three or more, thereby increasing manufacturing costs.

### SUMMARY OF THE INVENTION

An aspect of the present invention provides a power supply having multiple outputs capable of supplying multiple voltages according to operation modes while reducing power consumption due to heat generation of a DC/DC converter.

According to an aspect of the present invention, there is provided a switching mode power supply having multiple outputs, including: a DC/DC converter converting a DC voltage level according to a change in a load and including a primary coil and a secondary coil; a boost unit boosting an output voltage of the DC/DC converter in a first mode and outputting the boosted output voltage to an output terminal; a bypass unit bypassing the output voltage of the DC/DC converter to the output terminal in a second mode; and a boosting controller controlling the boost unit according to a voltage detected at a center tab of a secondary coil of the DC/DC converter.

The boosting controller may include: a driver generating a driving voltage according to the voltage detected from the center tab; and a control IC controlling the switch of the boost unit according to the driving voltage.

The driver may include: a diode having an anode connected to the center tab to rectify the voltage detected in the center tab; and a bipolar transistor having a common collector structure including a base connected to the cathode of the diode, and a collector connected to the output terminal of the DC/DC converter, and an emitter connected to a ground and the control IC.

According to another aspect of the present invention, there is provided a switching mode power supply having multiple outputs, including: a DC/DC converter converting a DC voltage level according to a change in a load; a boost unit boosting an output voltage of the DC/DC converter in a first mode and outputting the boosted output voltage to an output terminal; a bypass unit bypassing the output voltage of the DC/DC converter in a second mode and outputting the bypassed output voltage to the output terminal; and a boosting controller detecting the voltage of the output terminal to control the boost unit.

The boosting controller may include: a driver generating a driving voltage according to the voltage detected from the center tab; and a control IC controlling the switch of the boost unit according to the driving voltage.

The driver may include: a resistor having one end connected to the output terminal and detecting the voltage of the output terminal; and a bipolar transistor having a common collector structure including abase connected to the other end of the resistor, a collector connected to the output terminal of the DC/DC converter, and an emitter connected to a ground and the control IC.

The switching mode power supply having multiple outputs may further include: a feedback circuit unit feeding back any one of the output of the bypass unit or the output of the boost unit; and a PWM controller controlling a duty ratio of the DC/DC converter according to a signal transmitted from the feedback circuit unit.

The boost unit may include: an inductor having one end connected to the output terminal of the DC/DC converter; a diode having an anode connected to the other end of the inductor and a cathode connected to the output terminal; and a switch connected between a connection node of the inductor and the diode and the ground.

The bypass unit may include a bypass diode having an anode connected to the output terminal of the DC/DC converter and a cathode connected to the output terminal.

The first mode may be in an operation mode in which a load connected to the output terminal is in an operating state, and the second mode may be in a standby mode in which the load is in a standby state.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a circuit diagram of a power supply having multiple outputs according to an exemplary embodiment of the present invention;

FIG. 2 illustrates another exemplary embodiment of the present invention; and

FIG. 3 is a circuit diagram of a boost unit of a power supply having multiple outputs according to the exemplary embodiment of the present invention.

### DETAILED DESCRIPTION OF THE PREFERRED EMBODIMENT

Exemplary embodiments of the present invention will now be described in detail with reference to the accompanying drawings so that they could be easily practiced by those skilled in the art to which the present invention pertains. However, in describing the exemplary embodiments of the present invention, detailed descriptions of well-known functions or constructions will be omitted so as not to obscure the description of the present invention with unnecessary detail.

In addition, like reference numerals denote like elements throughout the drawings.

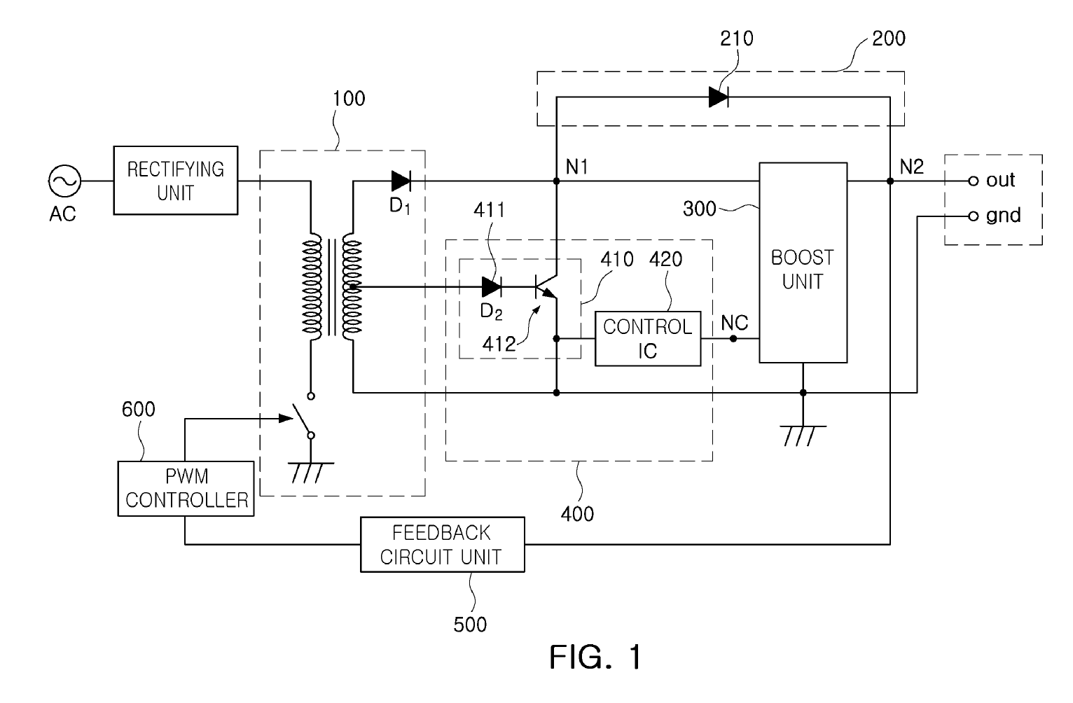

FIG. 1 is a circuit diagram of a power supply having multiple outputs according to an exemplary embodiment of the present invention.

Referring to FIG. 1, a power supply having multiple outputs according to an exemplary embodiment of the present invention may be configured to include a DC/DC converter 100, a bypass unit 200, a boost unit 300, a boosting controller 400, a feedback circuit unit 500, and a PWM controller 600.

The DC/DC converter 100 may transfer a DC voltage having a pulse type from a primary coil to a secondary coil by using an electromagnetic induction, such that a level of DC voltage is converted according to a turn ratio of a primary coil and a secondary coil and then the level-converted DC voltage is outputted. The voltage transferred to the secondary coil is rectified and output through a diode D1.

The DC voltage may be a DC voltage rectified by a rectifying unit that may be configured to include a bridge diode, or the like.

The bypass unit 200 may bypass and output the DC voltage converted in the DC/DC converter 100 to an output terminal OUT in a standby mode. Describing in detail, the bypass unit 200 may be a bypass diode 210 having an anode connected to the output terminal of the DC/DC converter 100 and a cathode connected to the output terminal OUT.

The boost unit 300 may boost the DC voltage converted in the DC/DC converter 100 to a high voltage necessary in a load and supply it to the load, in the operation mode.

The boosting controller 400 may detect voltage at a center tab of the secondary coil of the DC/DC converter 100 and control the boost unit 300 according to the detected voltage. Describing in detail, the boosting controller 400 may include a driver 410 generating a driving voltage according to the voltage detected from the center tab of the secondary coil, and a control IC 420 controlling the boost unit 300 according to the generated driving voltage.

In more detail, the driver 410 may include a diode 411 of which an anode is connected to the center tab of the secondary coil to rectify voltage detected at the center tab, and a bipolar transistor 413 having a common collector structure having a base connected to the cathode of the diode 411, a collector connected to the output terminal of the DC/DC converter 100, and an emitter connected to a ground and the control IC 420.

The feedback circuit unit 500 may feed back an output from the output terminal OUT connected to the load to the DC/DC converter 100. That is, any one of the output of the bypass unit 200 and the output of the boost unit 300 may be fed back to the DC/DC converter 100 according to the operation modes of the load. Describing in detail, the feedback circuit unit 500 may be configured of a photo coupler in consideration of the insulating DC/DC converter 100.

The PWM controller 600 may modulate a pulse width according to the voltage of the output terminal OUT transferred from the feedback circuit unit 500 to control the switching of the DC/DC converter 100.

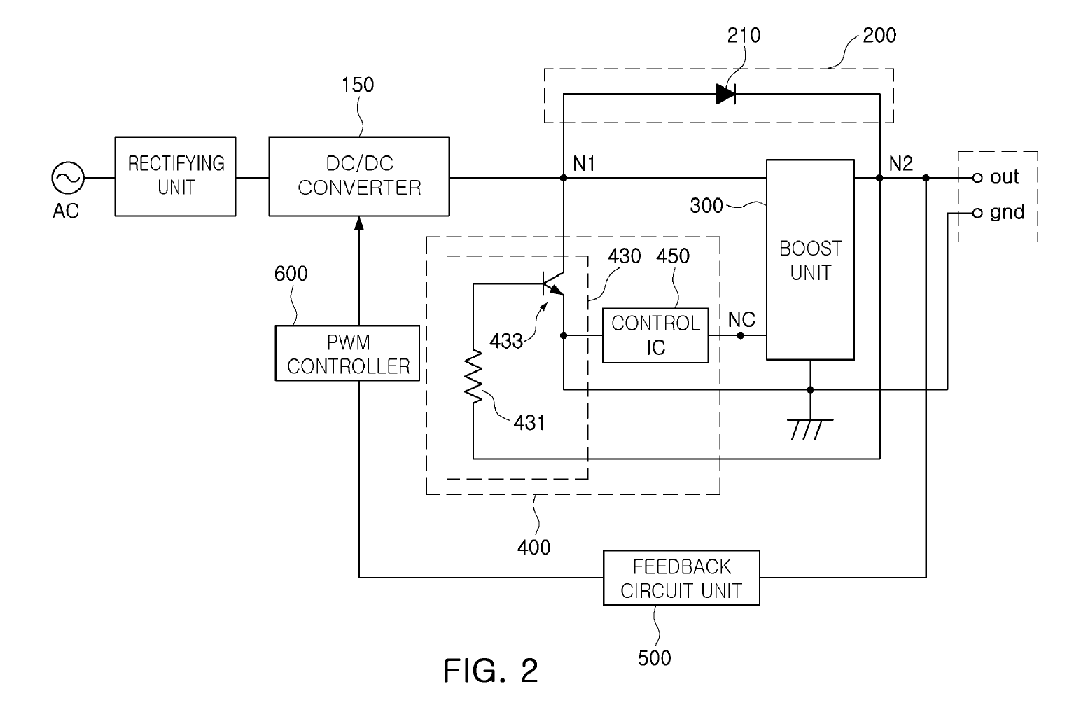

FIG. 2 is a circuit diagram of a power supply having multiple outputs according to another exemplary embodiment of the present invention.

Referring to FIG. 2, a power supply having multiple outputs according to an exemplary embodiment of the present invention may include the DC/DC converter 150, the bypass unit 200, the boost unit 300, the boosting controller 400, the feedback circuit unit 500, and the PWM controller 600. In this configuration, the configuration in the DC/DC converter 150, the feedback circuit unit 500, the bypass unit 200, and the boost unit 300 is in a similar manner to that of the power supply having multiple outputs according to the one exemplary embodiment of the present invention and therefore, the detailed description thereof will be omitted.

The boosting controller 400 may detect the voltage of the output terminal OUT and may control the boost unit 300 according to the detected voltage. In detail, the boosting controller 400 may include the driver 410 generating a driving voltage according to the voltage detected at the output terminal OUT connected to the load, and the control IC 420 controlling the boost unit 300 according to the generated driving voltage.

In more detail, the driver 410 may include a resistor 415 sensing the voltage of the output terminal OUT, and the bipolar transistor 413 having the common collector structure having a base connected to the resistor 415, a collector connected to the output terminal of the DC/DC converter 100, and an emitter connected to the ground and the control IC 420.

The output terminal OUT connected to the load may be configured of two terminals only, that is, an output terminal OUT from which multiple voltages are output, and a ground potential (GND), when the power supply having multiple outputs according to the exemplary embodiment of the present invention is applied to an adaptor.

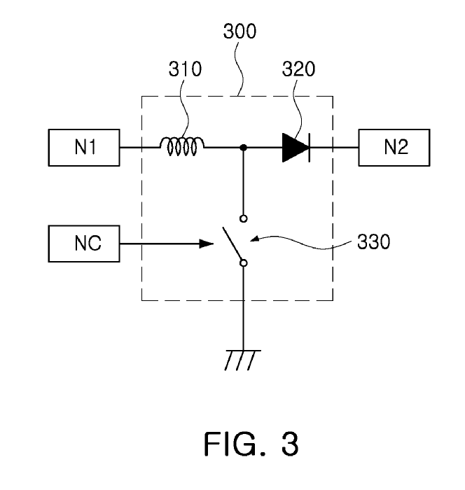

FIG. 3 is a circuit diagram of a boost unit of the power supply having multiple outputs according to the exemplary embodiment of the present invention.

Referring to FIG. 3, the boost unit 300 may be a boost converter that includes an inductor 310 of which one end is connected to an output node N1 of the DC/DC converter, a diode 320 having an anode connected to the other end of the inductor 310 and a cathode connected to an output terminal node N2, and a switch 330 connected between a connection node of the inductor 310 and the diode 320 and the ground. The switch may be controlled by the control IC through a connection node (NC) with the control IC.

In this configuration, the boost unit 300 is not limited thereto and may include all types of circuits boosting the level of DC voltage, such as a Buck-boost converter, or the like.

Hereinafter, the operations and effects according to embodiments of the present invention will be described in detail with reference to the accompanying drawings.

Referring to FIG. 1, the switching mode power supply with multi outputs according to the exemplary embodiment of the present invention will be described with reference to FIG. 1.

In FIG. 1, the DC/DC converter 100 according to the exemplary embodiment of the present invention may transfer the DC voltage having a pulse type input to the primary coil to the secondary coil by using the electromagnetic induction. In this case, the voltage level output to the secondary coil is determined according to the turn ratio of the primary coil and the secondary coil. The voltage transferred to the secondary coil is an AC voltage, which is rectified in a diode D1 and is output. The DC/DC converter 100 can control a switching duty by the PWM controller 600 to which the voltage of the output terminal OUT connected to the load is fed back.

The DC voltage output from the DC/DC converter 100 is a relatively low voltage necessary for a standby mode among operation modes of the load.

Meanwhile, the bypass unit 200 according to the exemplary embodiment of the present invention may transfer the output voltage of the DC/DC converter 100 intact, which is necessarily required to be of a low voltage when the load is in a second mode, the standby mode, to the load. The bypass unit 200 may be the bypass diode 210 having an anode connected to the output terminal of the DC/DC converter 100 and a cathode connected to the output terminal OUT.

The boost unit 300 may supply a voltage required when the load is in a first mode, the operation mode. That is, the boost unit 300 may serve to generate a relatively higher voltage than a voltage required when the load is in the standby mode according to the control of the boosting controller 400 and supply the generated voltage to the load.

As described above, due to the bypass unit 200 and the boost unit 300, the switching mode power supply having multiple outputs according to the exemplary embodiment of the present invention may supply the voltage of the DC/DC converter 100 to the load by using the bypass unit 200 when the load is in the standby mode and supply a boosted voltage higher than the voltage of the DC/DC converter 100 by using the boost unit 300 when the load is in the operation mode.

Therefore, the DC/DC converter 100 does not need to continually supply a relatively high voltage necessary in the operation mode, thereby reducing power consumption due to the heat generation, or the like.

The boosting controller 400 may include the driver 410 including the diode 411 and the bipolar transistor 413, and the control IC 420 controlling the boost unit 300.

The driver 410 may include the diode 411 rectifying the voltage detected at the center tab of the secondary coil of the DC/DC converter 100, and the bipolar transistor 413 using the rectified voltage as the base voltage.

Describing in more detail, the voltage detected at the center tab of the secondary coil of the DC/DC converter 100 may be rectified in the diode 411 and transferred to the base of the bipolar transistor 413. In this case, when the load is in the standby mode, the voltage is lower than a threshold voltage of the bipolar transistor 413, such that the bipolar transistor 413 is not conducted and does not supply the voltage to the control IC 420. Therefore, the boost unit 300 is not operated.

When the load is in the operation mode, the output of the DC/DC converter 100 may be slightly increased through the feedback circuit unit 500 and the PWM controller 600, and the voltage detected at the center tab may be also increased. In this case, the bipolar transistor 413 is turned-on, such that the control IC 420 is driven and the boosted voltage is supplied to the output terminal OUT. In this configuration, the bipolar transistor 413 has a common collector structure and the voltage output to the control IC 420 has a level lower than the base voltage rectified in the diode 411 and becomes a voltage level necessary in the control IC.

Referring to FIG. 2, the switching mode power supply having multiple outputs according to another exemplary embodiment of the present invention will be described.

As shown in FIG. 2, the switching mode power supply having multiple outputs according to another exemplary embodiment of the present invention has a different configuration only in the driver 410 of the boosting controller 400, and thus the repeated description of operations and effects thereof will be omitted.

The driver 410 may include a resistor 415 sensing the voltage of the output terminal OUT and the bipolar transistor 413 having the common collector structure having a base connected to the resistor 415, a collector connected to the output terminal of the DC/DC converter 150, and an emitter connected to the ground and the control IC 420.

When the load is in the standby mode, the resistor 415 may be preset not to turn the bipolar transistor 413 on, such that the control IC 420 cannot be driven. When the load is in the operation mode, the voltage of the output terminal OUT may be raised to be higher than a threshold voltage of the bipolar transistor 413 so as to drive the control IC 420.

Therefore, the switching mode power supply having multiple outputs according to another exemplary embodiment of the present invention may supply the voltage of the DC/DC converter 150 to the load by using the bypass unit 200 when the load is in the standby mode, and may supply a boosted voltage higher than the output voltage of the DC/DC converter 150, to the load by using the boost unit 300, when the load is in the operation mode, in a similar manner to the exemplary embodiment of FIG. 1.

In FIG. 3, the boost unit 300 is shown as the boost converter including the inductor 310, the diode 320, and the switch 330 as the exemplary embodiment of the present invention. The boost unit 300 may control the turn-on/off of the switch 330 to control a current conduction period of the inductor 310 according to the control of the control IC connected to the connection node NC, thereby boosting the input voltage.

As set forth above, according to the exemplary embodiment of the present invention, the DC/DC converter may generate a relatively low voltage, thereby reducing power consumption due to the heating generation, or the like, and removing the need for a separate transformer. In addition, two output terminals only are sufficient when the power supply having multiple outputs is applied to the external adaptor, thereby reducing the manufacturing costs thereof.

While the present invention has been shown and described in connection with the exemplary embodiments, it will be apparent to those skilled in the art that modifications and variations can be made without departing from the spirit and scope of the invention as defined by the appended claims.

What is claimed is:

1. A switching mode power supply having multiple outputs, comprising:
a DC/DC converter converting a DC voltage level according to a change in a load and including a primary coil and a secondary coil;
a boost unit boosting an output voltage of the DC/DC converter in a first mode and outputting the boosted output voltage to an output terminal;
a bypass unit bypassing the output voltage of the DC/DC converter to the output terminal in a second mode; and
a boosting controller controlling the boost unit according to a voltage detected at a center tab of a secondary coil of the DC/DC converter.

2. The switching mode power supply having multiple outputs of claim 1, further comprising:
a feedback circuit unit feeding back anyone of the output of the bypass unit or the output of the boost unit; and
a PWM controller controlling a duty ratio of the DC/DC converter according to a signal transmitted from the feedback circuit unit.

3. The switching mode power supply having multiple outputs of claim 1, wherein the bypass unit includes a bypass diode having an anode connected to the output terminal of the DC/DC converter and a cathode connected to the output terminal.

4. The switching mode power supply having multiple outputs of claim 1, wherein the boost unit includes:
an inductor having one end connected to the output terminal of the DC/DC converter;
a diode having an anode connected to the other end of the inductor and a cathode connected to the output terminal; and
a switch connected between the connection node of the inductor and the diode and a ground.

5. The switching mode power supply having multiple outputs of claim 4, wherein the boosting controller includes:
a driver generating a driving voltage according to the voltage detected from the center tab; and
a control IC controlling the switch of the boost unit according to the driving voltage.

6. The switching mode power supply having multiple outputs of claim 5, wherein the driver includes:
a diode having an anode connected to the center tab to rectify the voltage detected in the center tab; and
a bipolar transistor having a common collector structure including a base connected to the cathode of the diode, and a collector connected to the output terminal of the DC/DC converter, and an emitter connected to the ground and the control IC.

7. A switching mode power supply having multiple outputs, comprising:
a DC/DC converter converting a DC voltage level according to a change in a load;
a boost unit boosting an output voltage of the DC/DC converter in a first mode and outputting the boosted output voltage to an output terminal;
a bypass unit bypassing the output voltage of the DC/DC converter in a second mode and outputting the bypassed output voltage to the output terminal; and
a boosting controller detecting the voltage of the output terminal to control the boost unit.

8. The switching mode power supply having multiple outputs of claim 7, further comprising:
a feedback circuit unit feeding back anyone of the output of the bypass unit or the output of the boost unit; and
a PWM controller controlling a duty ratio of the DC/DC converter according to a signal transmitted from the feedback circuit unit.

9. The switching mode power supply having multiple outputs of claim 7, wherein the bypass unit includes a bypass diode having an anode connected to the output terminal of the DC/DC converter and a cathode connected to the output terminal.

10. The switching mode power supply having multiple outputs of claim 7, wherein the boost unit includes:
an inductor having one end connected to the output terminal of the DC/DC converter;
a diode having an anode connected to the other end of the inductor and a cathode connected to the output terminal; and
a switch connected between a connection node of the inductor and the diode and a ground.

11. The switching mode power supply having multiple outputs of claim 10, wherein the boosting controller includes:
a driver generating a driving voltage by detecting the voltage of the output terminal; and
a control IC controlling the switch of the boost unit according to the driving voltage.

12. The switching mode power supply having multiple outputs of claim 11, wherein the driver includes:
a resistor having one end connected to the output terminal and detecting the voltage of the output terminal; and
a bipolar transistor having a common collector structure including a base connected to the other end of the resistor, a collector connected to the output terminal of the DC/DC converter, and an emitter connected to the ground and the control IC.

13. The switching mode power supply having multiple outputs of claim 1, wherein the first mode is in an operation mode in which a load connected to the output terminal is in an operating state, and
the second mode is in a standby mode in which the load is in a standby state.

14. The switching mode power supply having multiple outputs of claim 7, wherein the first mode is in an operation mode in which a load connected to the output terminal is in an operating state, and
the second mode is in a standby mode in which the load is in a standby state.
